(19) United States
(12) Patent Application Publication
(10) Pub. No.: US 2009/0307151 A1
(43) Pub. Date: Dec. 10, 2009

(54) Method and device for automatically reconstruction and analyzing a travelled route

(76) Inventors: Dirk Schlierkamp-Voosen, Bonn (DE); Dietmar Schmitz, Linnich (DE); Waldemar Radi, Sankt Augustin (DE); Detlef Peine, Bonn (DE); Jochen Spranger, Bonn (DE); Jost Vierbuchen, Bonn (DE)

Correspondence Address: KENYON & KENYON LLP, ONE BROADWAY, NEW YORK, NY, 10004, US

(21) Appl. No.: 11/919,143

(22) PCT Filed: Mar. 22, 2006
(86) PCT No.: PCT/DE2006/000527

§ 371 Date: Jan. 9, 2008

(30) Foreign Application Priority Data
Apr. 20, 2005 (DE) 10 2005 018 557.6

(51) Int. Cl. G06F 17/00

(52) U.S. Cl. 705/400

(57) ABSTRACT

A method and device are provided concerning automatic reconstruction and evaluation of a traveled route, e.g., for offboard toll recording. In an embodiment, cost-effective onboard units, i.e., mobile telephony devices installed in a vehicle, are provided which record the position information, compress the recorded position information, and transmit the compressed position data to a main station. The main station is then able to reconstruct from the compressed position data the route a vehicle has actually traveled. An evaluation of the position information, e.g., for determining tolls, is carried out in a separate device. Since position data, digital maps and other operating data are now administered and processed in a central device, these data may be adapted in a simple and rapid manner, e.g., when updating the road geometries.

### FIELD OF INVENTION

The present invention relates generally to a method for automatic reconstruction and evaluation of a traveled route. More specifically, the present invention relates to a method and device for offboard toll recording. The present invention also relates to a mobile device and a central device which usable in a device for automatic reconstruction and evaluation of a traveled route.

### RELATED TECHNOLOGY INFORMATION

In order for road costs such as, for instance, costs for maintaining and expanding highway networks, to be charged to road users in a more equitable manner, systems for recording road usage charges, e.g., tolls, are utilized. In this context, two types may be distinguished: systems for flat toll collection and for a route-dependent toll collection.

A brief explanation of two available methods for route-dependent toll charges are as follows. The first method uses a toll collection system which is based on short-range communication with the aid of so-called traffic beacon systems. Such traffic beacon systems involve a microwave transmitter being implemented in a vehicle. Located along the toll road sections are corresponding microwave antennas, which detect passing vehicles equipped with a microwave transmitter and report them to a central station so that the required tolls are able to be charged.

The second method uses a toll collection system which is based on complex onboard systems. Onboard systems include so-called onboard units (OBU) which are installed in vehicles. The onboard units analyze instantaneous position finding information, which is recorded, for example, with the aid of a GPS navigation system. Using stored map data, the onboard unit calculates the traveled route and on this basis determines the used toll route sections, which are then transmitted to a main station. One disadvantage of such onboard systems is that the onboard units installed in the vehicle are technically complex and expensive devices. Further, the map data stored in the onboard units must constantly be updated when the road geometries change.

### SUMMARY OF INVENTION

Embodiments of the present invention provide a method and device for automatic reconstruction and evaluation of a traveled route, as well as a mobile device able to be used in this device and for this method, and on a main station, which allow the use of cost-effective mobile devices able to be installed in a vehicle, and permit simple as well as rapid system maintenance and border-crossing toll recording.

Embodiments of the present invention provide for cost-effective onboard units, i.e., mobile telephony devices installed in a vehicle, which detect position information, compress it and transmit the compressed position data to a main station. The main station is then able to reconstruct from the compressed position data the route a vehicle has actually traveled. An evaluation of the position information, for example, for the purpose of determining tolls, is implemented in a separate device instead of in the onboard units. Since position data, digital maps and other operating data are now administered and processed in a central device, these data may be adapted in a simple and rapid manner when updating the road geometries, for example.

Embodiments of the present invention provide for a method for automatic reconstruction and evaluation of a traveled route is outlined. To this end, position information concerning the routes traveled by the vehicle is recorded in a mobile position determination device, preferably at periodic intervals. In further embodiments, using a predefined filter algorithm, significant positions are determined from the position information. In further embodiments, only the significant positions are transmitted to a central device where a digital road map is stored. Further embodiments of the present invention permit a compressed data transmission from the mobile position determination device to the central device.

Every significant position is then assigned to at least one route segment of the digital route map. In further embodiments, in this context, one or a plurality of significant positions is linked to a plurality of route segments belonging to different roads as a function of the course of the roads of the digital map. Subsequently, at least one route segment is selected, which is used to reconstruct the traveled route. Each route segment of the reconstructed route is made available to an evaluation device for further analysis.

In further embodiments of the present invention, in order to enable correct reconstruction of the traveled route in the central device, both the starting and the destination position of the traveled route must be transmitted to the central device. In further embodiments of the present invention, since not all recorded position information is transmitted to the central device, but only the significant positions determined therefrom, it is sufficient if the significant positions are transmitted at predefined trigger points. The trigger points may be a function of the time, the road geometry, or they may be input manually.

In further embodiments, in order to ensure that the reconstructed route actually corresponds to the driven route, the route segments used to reconstruct the traveled route are selected as a function of the significant positions and data with regard to the direction, speed and/or distance. Direction, velocity and/or distance data are determined by, for example, the mobile position determination device and transmitted to the central device together with the acquired significant positions.

The significant positions, direction, velocity and/or distance data may be used as coefficients for an estimation algorithm with whose aid the route segments for reconstructing the traveled route are selected.

In order to be able to determine the optimal significant positions from the continuously recorded position information, the filter algorithm may take into account as coefficient also data concerning direction, speed and/or distance, or also changes in distance, time and/or direction.

Embodiments of the present invention are utilizable in the collection of tolls. In an example case, the toll to be paid is determined as a function of the selected route segments that make up the reconstructed route. Other utilizations are conceivable as well. For example, the selected route segments may be used for automatic preparation of a driver's logbook.

Accordingly, in embodiments of the present invention, a device for automatic reconstruction and evaluation of a traveled route is provided. The device has at least one mobile position determination device to acquire position information. A mobile position determination device is understood to denote a device that may be implemented in a vehicle. The position determination device may be a GPS-enabled navigation device.

In an embodiment of the present invention, a device for determining significant positions from the recorded position information is provided, which uses a filter algorithm. This determination device is also referred to as significant position extractor (SPE) or SPE device in the following text. In addition, the device includes a transmission device for transmitting acquired significant positions to a central station. At least one digital road map may be stored in the central station.

The central device includes a device which assigns at least one route segment of the digital route map to each significant position; a selection device which selects at least one route segment; and a route reconstruction device which reconstructs the traveled route as a function of the at least one selected route segment. The route segments selected to reconstruct the actually driven route are forwarded to an evaluation device for further processing.

In an embodiment of the present invention, at least a few of the selected route segments are subject to tolls. The evaluation device is therefore designed such that it is able to determine the toll to be paid for the reconstructed route.

In an embodiment of the present invention, in an expedient manner, the position determination device, the detection device and the transmission device are combined in one housing so as to form a unit, and installed in a vehicle.

In an embodiment of the present invention, the transmission device has a radio interface via which the data are transmitted to the central station.

In an embodiment of the present invention, the selection device utilizes an estimation algorithm to select the route segments that are utilized to reconstruct the actually traveled route.

Embodiments of the present invention involving a mobile device and/or by a main station are suitable for use in a device for reconstructing and evaluating a traveled route.

### BRIEF DESCRIPTION OF THE DRAWINGS

FIG. 1 shows a schematic illustration of an offboard toll recording system according to an embodiment of the present invention.

FIG. 2 shows sections of a route map in which position information and significant positions have been drawn in according to an embodiment of the present invention.

FIG. 3 shows the map detail shown in FIG. 2 in which the significant positions and the positions linked to the roads have been drawn in according to an embodiment of the present invention.

FIG. 4 shows the map detail shown in FIG. 3 in which the route sections to be selected to reconstruct the traveled route have been marked according to an embodiment of the present invention.

### DETAILED DESCRIPTION

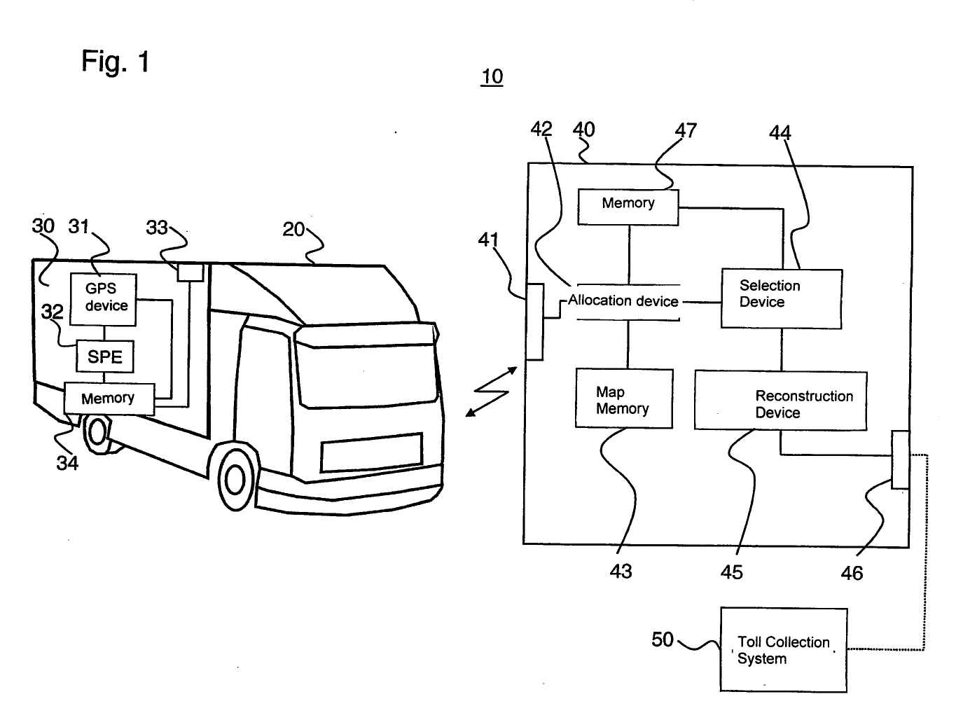

FIG. 1 shows an exemplary offboard toll collection system 10. Part of offboard toll collection system 10 is, for example, a toll recording system 50, a main station 40 and at least one vehicle 20, for example a vehicle that is equipped with a mobile radio terminal 30.

Mobile radio terminal 30 may have a conventional satellite receiver 31, which may be a GPS-enabled receiver and is used to determine the position of vehicle 20. Mobile radio terminal 30 additionally has a device 32, which is also referred to as significant position extractor (SPE). As explained in greater detail below, SPE device 32 uses a filter algorithm to generate significant positions from the position information regularly determined by satellite receiver 31, the significant positions being used to reconstruct the route actually traveled by vehicle 20.

Furthermore, satellite receiver 31 is configured for recording additional attributes such as direction, velocity and the traveled distance of vehicle 20.

These data, together with the determined significant positions, are able to be stored in a memory 34. The data stored in memory 34 are transmitted to main station 40 via an air interface 33. It should be noted at this point that mobile radio terminal 30 implements a data compression in that, instead of the continuously recorded position information of vehicle 20, only the significant positions obtained therefrom are transmitted to main station 40.

A trigger, which determines when the data stored in memory 34 are transmitted to main station 40, may be utilized in mobile radio terminal 30. The trigger points are able to be input manually. As an alternative, the trigger points may also be determined as a function of time and/or as a function of the road geometry.

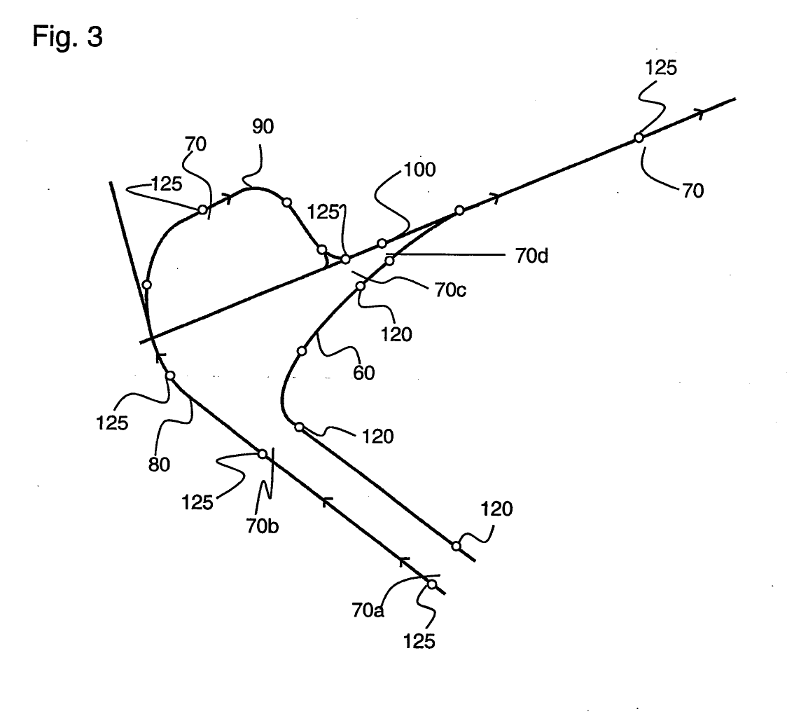

Main station 40 is essentially used to reconstruct the route actually driven by vehicle 20, taking the significant positions into account. To this end, the significant positions received via a receiver 41 are forwarded to an allocation device 42. Allocation device 42 accesses a map memory 43 in which at least one digital map is stored. Allocation device 42 is able to link any significant position to at least one road segment of the digital map. This functionality of allocation device 42 is illustrated in FIG. 3. As can be gathered from FIG. 3, each significant position 70 is assigned at least one so-called linked position 120 or 125, which are situated on different road segments. For instance, linked positions 120 are located on road 60, while linked positions 125 are located on roads 80, 90 and 100. Linked positions 120 and 125 as well as the road segments on which the linked positions are located are stored in a memory 47.

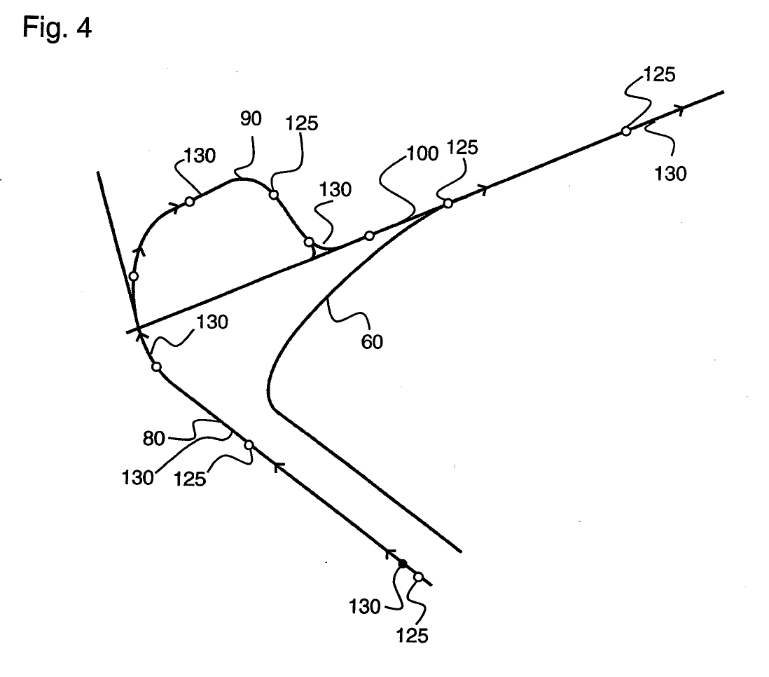

A selection device accesses memory 47 in order to select, with the aid of an estimation algorithm, the particular linked positions and thus the particular road segments that, in all likelihood, correspond to the road segments actually traveled by vehicle 20. The result of selection device 44 is schematically shown in FIG. 4. As illustrated in FIG. 4, selection device 44 has selected the road segments of roads 80, 90 and 100 on which vehicle 20 has most likely traveled. The road segments selected by selection device 44 then form the basis for the reconstruction of the route that vehicle 20 has actually taken. In the present example, the selected route segments are segments that are subject to tolls, which are able to be transmitted to toll recording system 50 via interface 46. Main station 40 and toll recording system 50 are able to communicate with each other via a wireless or a wire-bound connection.

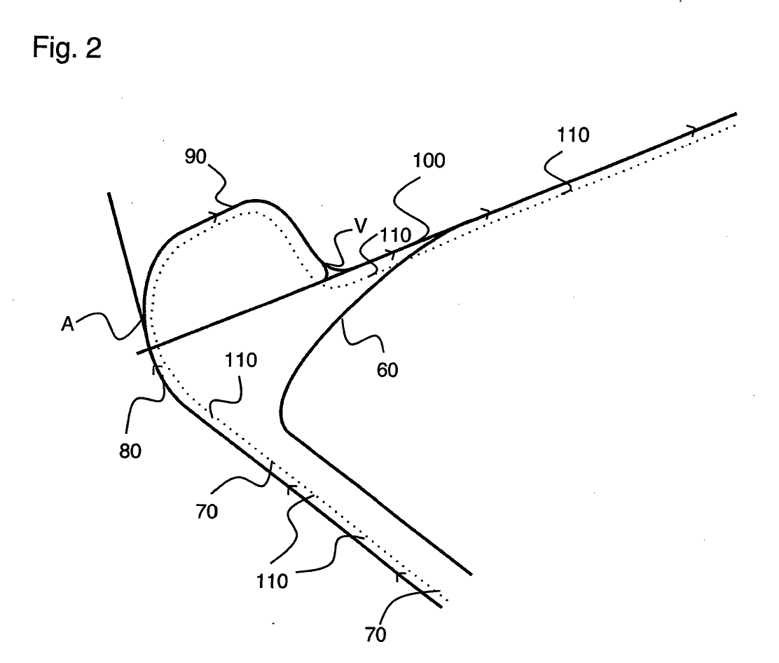

In the following text, the method of functioning of the offboard toll collection system shown in FIG. 1 will be elucidated in greater detail in conjunction with FIGS. 2 through 4.

Let us assume that vehicle 20 has traveled road 80 in the direction of the arrow up to the exit marked by A. Vehicle 20 leaves road 80 at exit A and continues via feeder 90 to the junction point marked by V. There, the driver turns left into road 100. While vehicle 20 is traveling along the indicated route, satellite receiver 31 of vehicle 20 continuously acquires position information, which is indicated by reference numeral 110 in FIG. 2. Furthermore, additional attributes such as the direction, speed and traveled distance of vehicle 20 are able to be determined by satellite receiver 31. The position information and the attributes may be stored in memory 34. From stored position information 110, SPE device 32 determines significant positions, which are denoted by reference numeral 70 in FIG. 2, using a filter algorithm and possibly taking the additionally stored attributes into account. Significant positions 70 may also be stored in memory 34. Merely for the sake of simplifying matters, position information 110 and significant positions 70 have been drawn in in a map detail that corresponds to the digital map stored in memory 43. Such a map is normally not used by mobile radio terminal 30.

From FIGS. 2, 3 and 4 it can be understood that sections of roads 60 and 80 as well as roads 110 and 60 run parallel and at a short distance from each other. As will be explained later, this affects the linkage of significant positions 70 to the road segments. For, because of measuring inaccuracies of satellite receiver 31, it regularly can happen that the periodically detected position information and the significant positions determined therefrom do not lie precisely on the actually driven road, but rather to the side of it. This is schematically illustrated in FIG. 2 and 3.

As can seen in FIGS. 2 and 3, the distance of successive significant positions 70 may vary in size. This is due to the fact that the filter algorithm of SPE device 32 is able to take into account both the course of the road, the velocity of the vehicle as well as other parameters when determining the significant positions.

In an embodiment, significant positions 70 are stored in memory 34 and the additionally determined attributes are transmitted from mobile radio terminal 30 to main station 40 every ten minutes. Allocation device 42 initially projects into the digital map significant positions 70 stored in map memory 43. Subsequently, allocation device 42 links the significant positions to the roads extending in predefined proximity to significant positions 70. Accordingly, in areas where several roads extend in predefined proximity to each other, significant positions 70 are able to be assigned to different roads. FIG. 3 shows the result from allocation device 42. According to that, in the lower map region, two significant positions 70a and 70b are assigned to two linked positions 120 and 125, respectively. In other words, the two significant positions 70a and 70b were linked to roads 60 and 80, respectively. In a similar manner, the two significant positions 70c and 70d at the upper end of the map detail were assigned to, respectively, roads 60 and 100.

The allocation result example illustrated in FIG. 3 is stored in memory 47. The additional attributes determined by satellite receiver 31 may also be stored in memory 47. With the aid of an estimation algorithm, for example, and the attributes transmitted by mobile radio terminal 30, selection device 44 then accesses memory 47 and selects the particular road segments that most likely were actually traveled by vehicle 20. Taking into account the attributes, which may include data concerning the direction, speed and/or distance, selection device 44 opts for positions 125 linked to roads 80, 90 and 100. As illustrated by FIG. 4, positions 125 are assigned road segments that are graphically delimited by dots 130. The road segments are selected by selection device 44 and forwarded to route reconstruction device 45, which reconstructs the route actually traveled by vehicle 20 on the basis of the selected road segments. The road segments selected to reconstruct the route are transmitted to toll recording system 50 via interface 46 of main station 40.

There may be a table stored in toll recording system 50, which contains all road segments that are subject to toll charges. Accordingly, based on road segments 130 transmitted by main station 40, toll recording system 50 is thus able to calculate the toll charges to be paid for the reconstructed route that corresponds to the route actually traveled by vehicle 20.

As one skilled in the art can appreciate, the embodiments described herein can be used in combination with and without each other.

What is claimed is:

1-14. (canceled)

15. A method for automatic reconstruction and evaluation of a traveled route, comprising the following method steps:
recording continuously position information in a mobile position determination device;
using a filter algorithm, significant positions are determined from the position information;
transmitting the significant positions to a main station where a digital route map is stored;
assigning every significant position to at least one route segment of the digital route map;
selecting at least one route segment;
reconstructing the driven route using the at least one route segment selected; and
making available each route segment of the reconstructed route to an evaluation device for further analysis.

16. The method as recited in claim 15, wherein the starting and destination position of the traveled route are made available to the main station.

17. The method as recited in claim 15, wherein at least one determined significant position is transmitted to the main station at predefined trigger points.

18. The method as recited in claim 15, wherein the route segments used to reconstruct the traveled route are selected as a function of the significant positions, direction, speed and/or distance data.

19. The method as recited in claim 15, wherein the route segments are selected with the aid of an estimation algorithm.

20. The method as recited in claim 15, wherein the filter algorithm determines the significant positions as a function of determined changes in distance, time and/or direction.

21. The method as recited in claim 15, wherein the toll to be paid for the reconstructed route is determined as a function of the selected route segments.

22. A device for automatic reconstruction and evaluation of a traveled route, comprising:
at least one mobile position determination device for acquiring position information; a device for determining significant positions from acquired position information, using a filter algorithm;
a transmission device for transmitting determined significant positions to a main station,
the main station having a memory for storing at least one digital route map;
a device, which assigns at least one route segment of the digital route map to each significant position;
a selection device, which selects at least one route segment; and
a route reconstruction device, which reconstructs the traveled route as a function of the at least one selected route segment; and
an evaluation device for analyzing each route segment of the reconstructed route.

23. The device as recited in claim 22, wherein the position determination device, the determination device and the transmission device may form one unit and are installed in a vehicle.

24. The device as recited in claim 22, wherein the transmission device includes a radio interface.

25. The device as recited in claim 22, wherein the selected route segments are route segments for which tolls are charged, and
the evaluation device is designed to determine the tolls to be paid for the reconstructed route.

26. The device as recited in claim 22, wherein the selection device selects route segments with the aid of an estimation algorithm.

27. The device as recited in claim 22, further comprising:
a mobile device for use in the device having:
at least one position determination device for acquiring position information;
a device for determining significant positions from the acquired position information, using a filter algorithm; and
a wireless transmission device for transmitting determined significant positions.

28. The device as recited in claim 22, further comprising:
a main station for reconstructing a route, for use in the device, having:
a memory device for storing at least one digital map;
a device for receiving data that include significant positions;
a device which assigns at least one route segment of the digital route map to each significant position;
a selection device, which selects at least one route segment; and
a device, which reconstructs the traveled route as a function of the at least one selected route segment.
